(19) United States
(12) Patent Application Publication
(10) Pub. No.: US 2009/0091548 A1
(43) Pub. Date: Apr. 9, 2009

(54) TOUCH PANEL

(76) Inventors: Shoji FUJII, Osaka (JP); Koji Tanabe, Osaka (JP); Kenichi Matsumoto, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/245,948

(22) Filed: Oct. 6, 2008

(30) Foreign Application Priority Data
Oct. 9, 2007 (JP) 2007-263090

(51) Int. Cl. G06F 3/041; C08F 118/00

(52) U.S. Cl. 345/173

(57) ABSTRACT

A touch panel includes an upper substrate, a lower substrate, an insulating spacer, a bonding layer, and a water-absorbing layer. This structure allows suppressing dew formation, so that the touch panel which is excellent in visibility and capable of positive operation is obtainable.

### FIELD OF THE INVENTION

The present invention relates to touch panels to be used for operating a variety of electronic apparatuses.

### BACKGROUND OF THE INVENTION

In recent years, various electronic apparatuses, including cell phones and car navigation systems, have been downsized and sophisticated. This market trend has increased the use of touch panel mounted to various apparatuses for switching functions of those apparatuses. For instance an optically transparent touch panel is mounted on the front of a display element such as a liquid crystal display device (LCD). Through this touch panel, letters, symbols, or patterns displayed on the display element behind the touch panel can be recognized, and then selected by a user with a finger or a dedicated pen through depressing the touch panel, thereby switching the functions. A touch panel excellent in visible recognition and workability among others is thus demanded from the market.

The conventional touch panel discussed above is described hereinafter with reference to FIG. 10, which shows a sectional view of the conventional touch panel. As shown in FIG. 10, touch panel 100 includes film-like light transmissible upper substrate 101 and light transmissible lower substrate 102. Substrate 101 has light transmissible upper conductive layer 103 made from material including indium tin oxide at its lower face, substrate 102 has light transmissible lower conductive layer 104 made from material including indium tin oxide at its upper face.

Multiple dot-spacers 105 made of insulating resin are formed at given intervals on an upper face of lower conductive layer 104. A pair of upper electrodes (not shown) is formed at both ends of upper conductive layer 103. A pair of lower electrodes (not shown) is formed at both ends of lower conductive layer 104 and along the direction orthogonal to the upper electrodes.

Insulating spacer 106 shaped like a picture frame is formed on a perimeter of the upper face of lower substrate 102, or a perimeter of the lower face of upper substrate 101. Bonding layer 107 is applied to an upper face or a lower face of insulating spacer 106 so that upper substrate 101 is stuck to lower substrate 102 at their perimeters with bonding layer 107, and upper conductive layer 103 confronts lower conductive layer 104 with a given space therebetween. Touch panel 100 is thus formed.

Lower substrate 102 of touch panel 100 thus structured is bonded to the front face of a display element (not shown) such as an LCD at its lower face with adhesive (not shown). The upper electrodes and the lower electrodes are connected to an electronic circuit (not shown) of an electronic apparatus (not shown), so that touch panel 100 is mounted to the electronic apparatus.

In the foregoing structure, an upper face of upper substrate 101 is depressed by a user with a finger or a dedicated pen in response to a display shown on the display element placed behind touch panel 100. Upper substrate 101 is thus bowed by this depression, and upper conductive layer 103 corresponding to the depressed place touches lower conductive layer 104.

The electronic circuit applies a voltage to the upper electrode and the lower electrode sequentially. The voltage applied is then sequentially applied to both the ends of upper conductive layer 103 and both the ends of lower conductive layer 104 orthogonal to layer 103. The electronic circuit detects the depressed place with a voltage ratio of the upper electrodes and a voltage ratio of the lower electrodes. A detection of the depressed place allows switching a variety of functions of the electronic apparatus.

For instance, the upper face of upper substrate 101 is depressed at a place where a desirable menu is displayed while multiple menus are displayed on the display element, and then the electronic circuit detects the depressed place, so that a desirable menu is selected out of the multiple menus.

However, conventional touch panel 100 described above, for example, is used in an electronic apparatus, e.g. a car navigation system installed in a car, it is sometimes cooled quickly by an air-conditioner (not shown) from a condition of high temperature and high humidity, then the air in a space between upper conductive layer 103 and lower conductive layer 104 is cooled quickly, which incurs dew formation. This dew formation lowers the visibility of a display shown on the display element placed behind the touch panel 100. On top of that, the dew formation sometimes makes the electrical contact unstable between upper conductive layer 103 and lower conductive layer 104.

Conventional touch panel 100 is disclosed in, e.g. Unexamined Japanese Patent Application Publication No. 2005-274667.

### SUMMARY OF THE INVENTION

The present invention aims to provide a touch panel that can prevent dew formation in a space between an upper substrate and a lower substrate due to a change in operating temperature of the touch panel, and this touch panel is excellent in visibility and capable of positive operation.

The touch panel of the present invention includes an upper substrate, a lower substrate, an insulating spacer, a bonding layer, and a water-absorbing layer. The upper substrate is light transmissible and includes an upper conductive layer at its lower face. The lower substrate is light transmissible and includes a lower conductive layer at its upper face. The insulating spacer is formed at a perimeter of the lower face of the upper substrate or at a perimeter of the upper face of the lower substrate. The bonding layer is formed on an upper face or a lower face of the insulating spacer. The water-absorbing layer is formed inside the insulating spacer. The foregoing structure allows suppressing dew formation in the touch panel, so that the touch panel which is excellent in visibility and capable of positive operation is obtainable.

Another touch panel of the present invention includes an upper substrate, a lower substrate, multiple dot-spacers, an insulating spacer, and a bonding layer. The upper substrate is light transmissible and includes an upper conductive layer at its lower face. The lower substrate is light transmissible and includes a lower conductive layer at its upper face. The dot-spacers are formed on an upper face of the lower conductive layer. The insulating spacer is formed at a perimeter of the lower face of the upper substrate or at a perimeter of the upper face of the lower substrate. The bonding layer is formed on an upper face or a lower face of the insulating spacer. Polymer material of water absorption property is dispersed into at least one of the dot-spacers, the insulating spacer, and the bonding layer. The foregoing structure allows suppressing dew formation in the touch panel, which is excellent in visibility and capable of positive operation. On top of that, this touch panel can be manufactured fairly easier.

### BRIEF DESCRIPTION OF THE DRAWINGS

FIG. 1 shows a cross section of a plan view of a touch panel in accordance with a first embodiment of the present invention.

FIG. 2 shows a cross section of a lateral view of the touch panel shown in FIG. 1 cut along line 2-2.

FIG. 3 shows a schematic plan view of an upper substrate of the touch panel shown in FIG. 1.

FIG. 4 shows a sectional view of the touch panel shown in FIG. 2 cut along line 4-4.

FIG. 5 shows a cross section of a lateral view of another touch panel in accordance with the first embodiment of the present invention.

FIG. 6 shows a sectional view of still another touch panel in accordance with the first embodiment of the present invention.

FIG. 7 shows a sectional view of yet another touch panel in accordance with the first embodiment of the present invention.

FIG. 8 shows a cross section of a lateral view of a touch panel in accordance with a second embodiment of the present invention.

FIG. 9 shows a cross section of a lateral view of another touch panel in accordance with the second embodiment of the present invention.

FIG. 10 shows a cross section of a lateral view of a conventional touch panel.

### DETAILED DESCRIPTION OF THE INVENTION

Exemplary embodiments of the present invention are demonstrated hereinafter with reference to the accompanying drawings.

### Embodiment 1

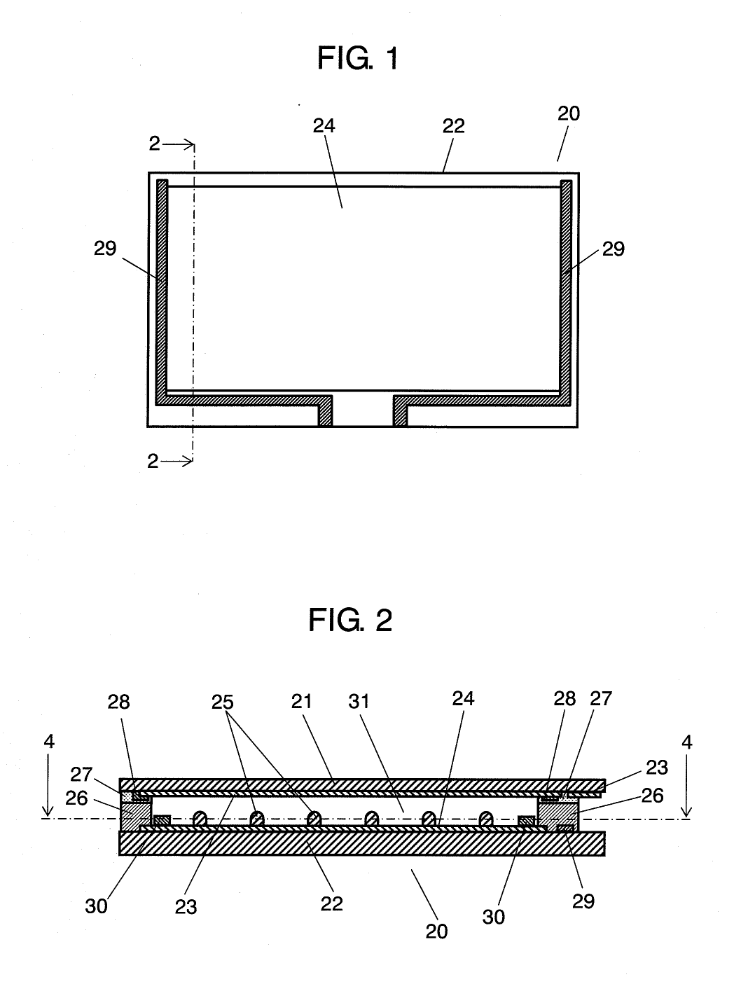

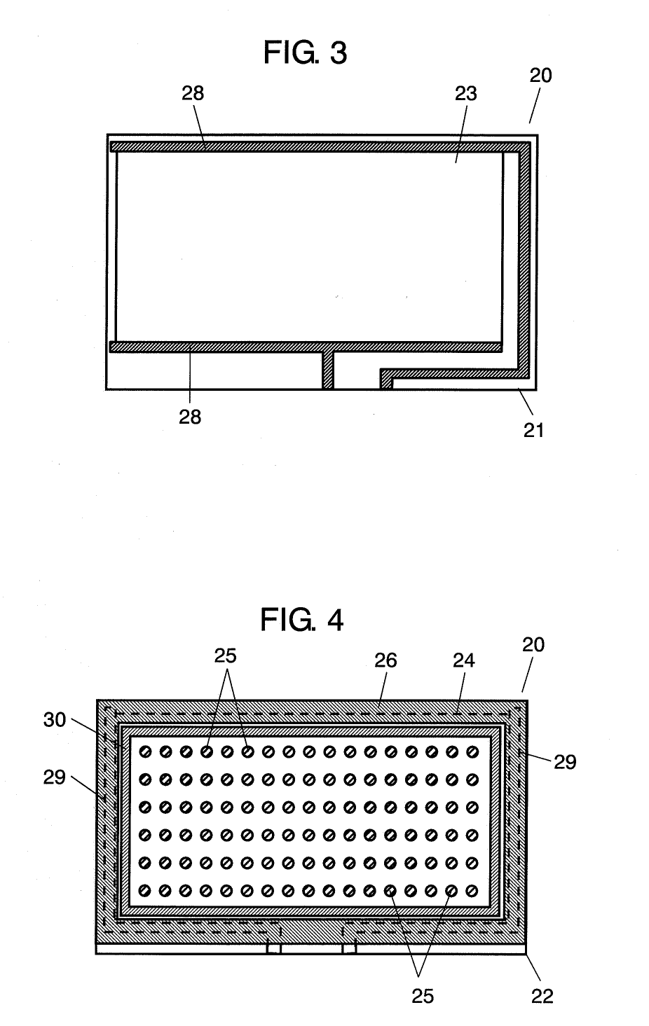

FIG. 1 shows a cross section of a plan view of touch panel 20 in accordance with the first embodiment of the present invention. FIG. 2 shows a cross section of a lateral view of touch panel 20 shown in FIG. 1 cut along line 2-2. FIG. 3 shows a schematic plan view of upper substrate 21 of touch panel 20 shown in FIG. 1. FIG. 4 shows a sectional view of touch panel 20 shown in FIG. 2 cut along line 4-4. As shown in FIG. 1-FIG. 4, touch panel 20 includes film-like and light transmissible upper substrate 21 and light transmissible lower substrate 22. Upper substrate 21 is made from material including polyethylene terephthalate, polycarbonate resin, or polyether sulfone. Lower substrate 22 is made from material including glass, acrylic resin, or polycarbonate resin. Light transmissible upper conductive layer 23 is formed on a lower face of upper substrate 21, and light transmissible lower conductive layer 24 is formed on an upper face of lower substrate 22. Both of conductive layers 23 and 24 are made from material including indium tin oxide or tin oxide and formed by, e.g. a sputtering method.

On an upper face of lower conductive layer 24, multiple dot-spacers 25 are formed at predetermined intervals. Dot-spacers 25 are made from insulating resin such as epoxy resin or silicone resin. At both ends of upper conductive layer 23, a pair of upper electrodes 28 made from conductive material such as silver or carbon is formed. At both ends of lower conductive layer 24, a pair of lower electrodes 29 made from conductive material such as silver or carbon is formed in an orthogonal direction to both the ends of upper conductive layer 23.

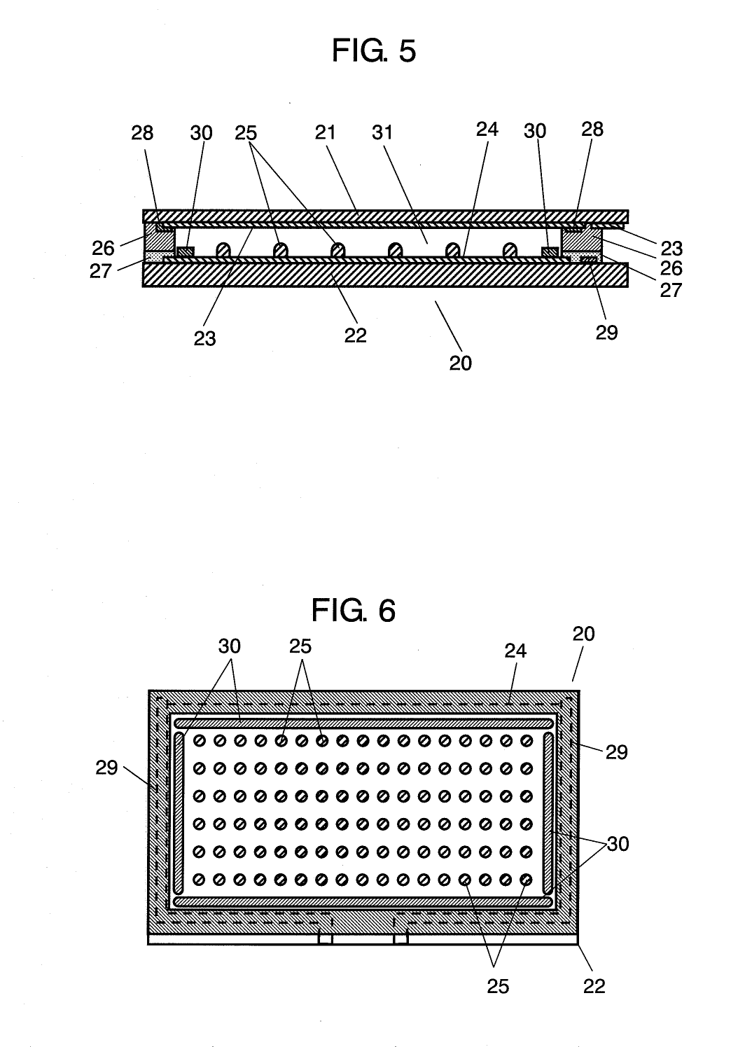

Insulating spacer 26 shaped like a picture frame is formed at perimeter of the upper face of lower substrate 22. Spacer 26 is made from material including epoxy resin, polyester resin, or acrylic resin and formed by, e.g. a printing method. Upper substrate 21 is bonded to lower substrate 22 at their perimeters with bonding layer 27, made from material including acrylic resin, epoxy resin or rubber, applied on an upper face of insulating spacer 26. Upper conductive layer 23 thus confronts lower conductive layer 24 with space 31 having a given interval therebetween. However, as shown in FIG. 5, insulating spacer 26 can be formed at the perimeter of the lower face of upper substrate 21, and bonding layer 27 can be formed on a lower face of spacer 26. The picture frame in this context indicates an outside frame of a polygon such as a quadrangle.

On top of that, water-absorbing layer 30 is formed like a picture frame and inside insulating spacer 26, to be more specific, on the upper face of lower conductive layer 24 at the vicinity of inner wall of insulating spacer 26. Water-absorbing layer 30 is made from polymer material of water absorption property. The polymer material of water absorption property includes one of acrylic acid vinyl alcohol copolymerization, sodium polyacrylate, sodium acrylate acryl amide copolymer, modified polyethylene oxide, polyhydroxy acrylate, and polyhydroxy methacrylate. Touch panel 20 is thus constructed.

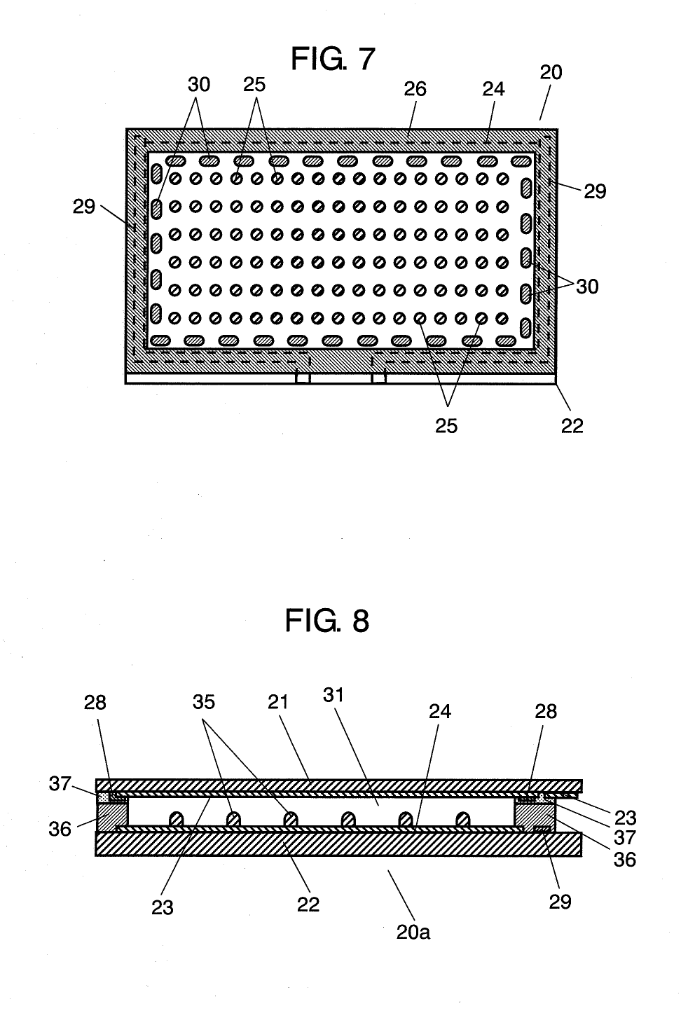

Water-absorbing layer 30 can be produced fairly easier through the following method: a paste including the foregoing polymer material of water absorption property is applied onto the place discussed above through a needle dispenser, or applied by a printing method, and then dried. The paste is formed by melting the foregoing polymer material of water absorption property into a solution such as carbitol or isophorone, or by dispersing the foregoing polymer material of water absorption property into water solution of dissolved resin such as polyvinyl alcohol resin having some viscosity. Water-absorbing layer 30 can be formed like a plurality of divided lines as shown in FIG. 6 considering the simplicity of the production thereof, or it can be formed like a plurality of dots which are placed with predetermined intervals as shown in FIG. 7.

Lower substrate 22 of touch panel 20 thus constructed is bonded to a front face of a display element (not shown) such as an LCD at its lower face with adhesive (not shown). On top of that, the pair of upper electrodes 28 and the pair of lower electrodes 29 are connected to the electronic circuit (not shown) of the electronic apparatus (not shown), so that touch panel 20 is mounted to the electronic apparatus.

A user of the electronic apparatus depresses an upper face of upper substrate 21 with a finger or a dedicated pen in response to a display shown on the display element placed behind touch panel 20. This depression bows upper substrate 21, and upper conductive layer 23 touches lower conductive layer 24 at its place corresponding to the depressed place of upper substrate 21.

The electronic circuit applies a voltage to upper electrodes 28 and lower electrodes 29 sequentially, and the voltage thus applied is then applied sequentially to both the ends of upper conductive layer 23 and both the ends of lower conductive layer 24 formed in an orthogonal direction to both the ends of upper conductive layer 23. The electronic circuit detects the depressed place with a voltage ratio of upper electrodes 28 and a voltage ratio of lower electrodes 29, thereby switching various functions of the electronic apparatus.

For instance, a user depresses the upper face of upper substrate 21 at a place where a desirable menu with other multiple menus is displayed on the display element. The electronic circuit detects this depressed place, so that the desirable menu can be selected out of the multiple menus.

When touch panel 20 is used in an electronic apparatus, e.g. a car navigation system installed in a car, it is sometimes cooled quickly by an air-conditioner (not shown) from a condition of high temperature and high humidity, then the air in space 31 is cooled quickly, which incurs dew formation. In the case of a conventional touch panel, this dew formation lowers the visibility of a display shown on the display element placed behind the touch panel. On top of that, the dew formation sometimes makes the electrical contact unstable between the upper conductive layer and the lower conductive layer of the conventional touch panel. However, since touch panel 20 in accordance with this first embodiment includes water-absorbing layer 30 inside insulating spacer 26, water drops are prevented from occurring in space 31. In other words, water-absorbing layer 30 absorbs water contained in the air within space 31, thereby suppressing the dew formation caused by a change in operating temperature of touch panel 20. Water drops produced by the dew formation are thus prevented from attaching to upper conductive layers 23 and lower conductive layers 24, and good visibility of the display element behind touch panel 20 can be maintained. At the same time, a stable electrical contact can be maintained between upper conductive layer 23 and lower conductive layer 24.

As discussed above, this first embodiment prepares water-absorbing layer 30 inside insulating spacer 26 which is formed at the perimeter of the lower face of upper substrate 21 or at the perimeter of the upper face of lower substrate 22. Water-absorbing layer 30 absorbs the water within space 31, thereby suppressing dew formation caused by the change in operating temperature of touch panel 20. Touch panel 20 which is excellent in visibility and capable of positive operation is thus obtainable with ease.

### Embodiment 2

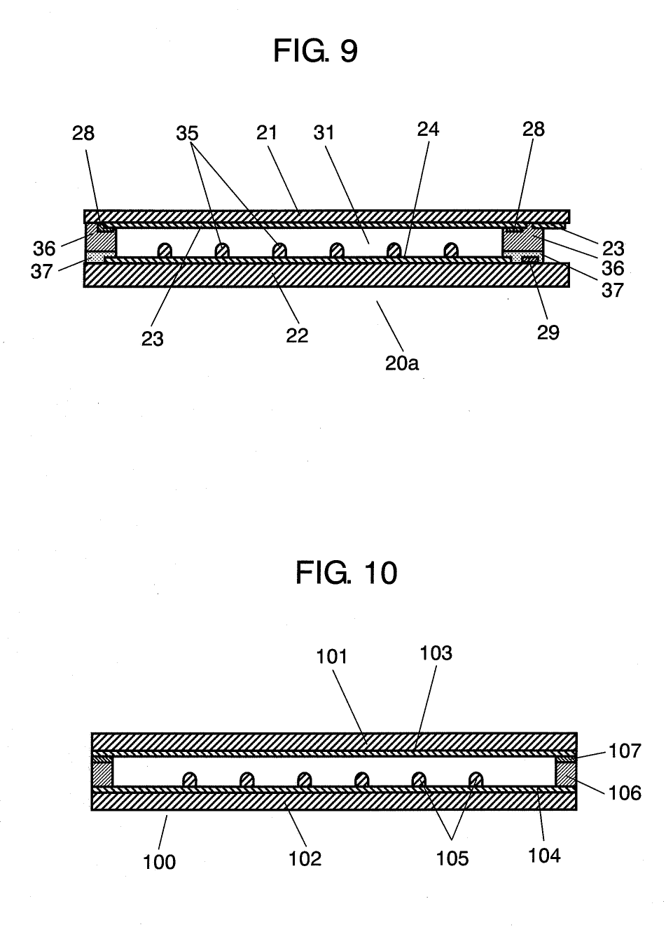

FIG. 8 shows a cross section of a lateral view of touch panel 20a in accordance with the second embodiment of the present invention. FIG. 9 shows a cross section of a lateral view of another touch panel 20a in accordance with the second embodiment of the present invention. In touch panel 20a, similar elements to those of touch panel 20 in accordance with the first embodiment have the same reference marks and the detailed descriptions thereof are omitted here. As shown in FIG. 8 and FIG. 9, touch panel 20a has no water-absorbing layer 30, but instead of this, polymer material of water absorption property is dispersed in dot-spacers 35. The polymer material of water absorption property includes one of acrylic acid vinyl alcohol copolymerization, sodium polyacrylate, sodium acrylate acryl amide copolymer, modified polyethylene oxide, polyhydroxy acrylate, and polyhydroxy methacrylate.

On top of that, the polymer material of water absorption property similar to that is dispersed in dot-spacers 35 is dispersed in insulating spacer 36 and bonding layer 37. Touch panel 20a is thus constructed.

Touch panel 20a discussed above is bonded to the front face of the display element, and upper electrodes 28 and lower electrodes 29 are connected to the electronic circuit of the electronic apparatus, so that touch panel 20a is mounted to the electronic apparatus. The upper face of upper substrate 21 is depressed by a user with a finger or a dedicated pen, so that upper conductive layer 23 touches lower conductive layer 24 at a place corresponding to the depressed place. The electronic circuit thus detects the depressed place. The works of touch panel 20a is similar to the works of touch panel 20 described in the first embodiment, so that the details are omitted here.

Touch panel 20a is used in, e.g. a car navigation system installed in a car, and sometimes cooled by an air conditioner from a condition of high temperature and high humidity. The presence of dot-spacers 35, insulating spacer 36 and bonding layer 37, in which the polymer material of water absorption property is dispersed, allows suppressing the production of water drops in space 31.

To be more specific, the polymer material of water absorption property dispersed in dot-spacers 35, insulating spacer 36 and bonding layer 37 absorbs the water contained in the air within space 31, so that the dew formation caused by a change in operating temperature of touch panel 20a can be suppressed. Good visibility of the display element placed behind touch panel 20a can be thus obtained. At the same time, a stable electrical contact can be maintained between upper conductive layer 23 and lower conductive layer 24. On top of that, since the polymer material of water absorption property is dispersed in dot-spacers 35, insulating spacer 36 and bonding layer 37, there is no need to form additional structural element, so that the number of structural elements is not increased. As a result, touch panel 20a manufactured fairly easier at an inexpensive cost is thus obtainable with ease.

In the foregoing description, the polymer material of water absorption property is dispersed into all the three components, namely, dot-spacers 35, insulating spacer 36, and bonding layer 37. However, the polymer material can be dispersed into only one or two of the foregoing three components.

As discussed above, the second embodiment prepares the polymer material of water absorption property dispersed into at least one of dot-spacers 35, insulating spacer 36, and bonding layer 37. This structure allows the polymer material of water absorption property dispersed into these components to absorb the water within space 31, so that the dew formation caused by the change in operating temperature of touch panel 20a can be suppressed. As a result, touch panel 20a which is excellent in visibility and capable of positive operation is thus obtainable with ease, and touch panel 20a can be manufactured fairly easier.

What is claimed is:

1. A touch panel comprising:
an upper substrate having light transmission property and including an upper conductive layer formed on a lower face of the upper substrate;
a lower substrate having light transmission property and including a lower conductive layer formed on an upper face of the lower substrate;
an insulating spacer formed at one of a perimeter of the lower face of the upper substrate and a perimeter of the upper face of the lower substrate;
a bonding layer formed on one of an upper face and a lower face of the insulating spacer; and
a water-absorbing layer formed inside the insulating spacer.

2. The touch panel of claim 1, wherein the water-absorbing layer is formed on an upper face of the lower conductive layer and is shaped like one of a plurality of divided lines, a picture frame, and a plurality of dots placed with predetermined intervals.

3. The touch panel of claim 1, wherein the water-absorbing layer includes polymer material of water absorption property.

4. The touch panel of claim 3, wherein the polymer material of water absorption property includes one of acrylic acid vinyl alcohol copolymerization, sodium polyacrylate, sodium acrylate acryl amide copolymer, modified polyethylene oxide, polyhydroxy acrylate, and polyhydroxy methacrylate.

5. The touch panel of claim 2, wherein the water-absorbing layer includes polymer material of water absorption property.

6. The touch panel of claim 5, wherein the polymer material of water absorption property includes one of acrylic acid vinyl alcohol copolymerization, sodium polyacrylate, sodium acrylate acryl amide copolymer, modified polyethylene oxide, polyhydroxy acrylate, and polyhydroxy methacrylate.

7. A touch panel comprising:
an upper substrate having light transmission property and including an upper conductive layer formed on a lower face of the upper substrate;
a lower substrate having light transmission property and including a lower conductive layer formed on an upper face of the lower substrate;
a plurality of dot-spacers formed on an upper face of the lower conductive layer;
an insulating spacer formed at one of a perimeter of the lower face of the upper substrate and a perimeter of the upper face of the lower substrate; and
a bonding layer formed on one of an upper face and a lower face of the insulating spacer,
wherein polymer material of water absorption property is dispersed in at least one of the dot-spacers, the insulating spacer, and the bonding layer.

8. The touch panel of claim 7, wherein the polymer material of water absorption property includes one of acrylic acid vinyl alcohol copolymerization, sodium polyacrylate, sodium acrylate acryl amide copolymer, modified polyethylene oxide, polyhydroxy acrylate, and polyhydroxy methacrylate.
